(19) United States
(12) Patent Application Publication
(10) Pub. No.: US 2019/0189312 A1
(43) Pub. Date: Jun. 20, 2019

(54) Pretreatment of Thick-Film Aluminum Electrode for Metal Plating

(71) Applicant: National Cheng Kung University, Tainan (TW)

(72) Inventor: Wen-Hsi Lee, Tainan (TW)

(21) Appl. No.: 15/846,482

(22) Filed: Dec. 19, 2017

(51) Int. Cl. H01C 17/28; H01C 1/142; H01C 17/00; C25D 3/30; C25D 3/12; C25D 5/12; C25D 5/44; C25D 11/08; C23F 1/20; C23F 1/36; B24B 31/02

(52) U.S. Cl. CPC H01C 17/281; H01C 1/142; H01C 17/006; C25D 3/30; C25D 3/12; B24B 31/02; C25D 5/44; C25D 11/08; C23F 1/20; C23F 1/36; C25D 5/12

(57) ABSTRACT

A method is provided for pretreating a thick-film aluminum electrode. The pretreatment is processed before subsequent metal plating. the thick-film aluminum electrode is pretreated with a purely mechanical or chemical treatment or a mixture of mechanical and chemical treatments; the chemical treatment is an alkaline/acid washing or a chemical anodizing; The surface of the thick-film aluminum electrode is made even and alumina, a nonconductive substance, on the surface is removed. The thick-film aluminum electrode has a surface with evenness and low oxygen content. The thick-film aluminum electrode has similar quality as the thick-film electrode of noble metal silver for subsequent metal plating.

### TECHNICAL FIELD OF THE INVENTION

The present invention relates to a pretreatment of a thick-film aluminum electrode; more particularly, to significantly improving the evenness and oxygen content of the surface of the thick-film aluminum electrode through a purely mechanical treatment, a purely chemical alkaline/acid washing treatment, a mixture of mechanical and chemical treatments or a chemical proper anodizing treatment.

### DESCRIPTION OF THE RELATED ARTS

Currently, metal silver can be easily used as an electrode for subsequent nickel- or tin-plating. Yet, because silver is a noble metal, a conductive material mainly made of noble metal silver powder will result in expensive material cost and is susceptible to price ups and downs. For reducing material cost, a thick-film electrode of base metal aluminum is chosen to replace a thick-film electrode of noble metal silver. However, roughness and easy oxidization of the surface of the thick-film aluminum electrode will cause problem to subsequent metal plating.

Generally, a thick-film aluminum electrode has a rough surface with pores. As shown in FIG. 7, the thick-film aluminum electrode is processed with subsequent metal plating (plating nickel and tin) to be compared with a general thick-film silver electrode plated with metal nickel and tin. As shown in FIG. 8, it is clearly found that the thick-film silver electrode can be electroplated with continuous and very smooth layers of nickel and tin. Yet, nickel and tin are discontinuously plated on the thick-film aluminum electrode with irregularities of convex and concave. The reason is that the original unevenness and the alumina generated on the surface of the thick-film aluminum electrode causes the unevenness of the plated layer of metal nickel and tin.

The thick-film silver electrode has smooth surface and is not easily oxidized, which can be easily applied for subsequent electroplating. But, silver is a noble metal, whose cost is high and unstable. If the substituent thick-film aluminum electrode is considered, its rough and easily oxidized surface will cause difficulty in its application for subsequent electroplating. Hence, the prior arts do not fulfill all users' requests on actual use.

### SUMMARY OF THE INVENTION

The main purpose of the present invention is to significantly improve evenness and oxygen content of the surface of a thick-film aluminum electrode through a purely mechanical treatment, a purely chemical alkaline/acid washing treatment, a mixture of mechanical and chemical treatments or a chemical proper anodizing treatment, where the novel thick-film aluminum electrode has similar quality as a thick-film electrode of noble metal silver for subsequent metal plating.

To achieve the above purpose, the present invention is a pretreatment of a thick-film aluminum electrode for metal plating, where a thick-film aluminum electrode is pretreated before performing subsequent metal plating; the thick-film aluminum electrode is pretreated with a purely mechanical treatment, a purely chemical alkaline or acid washing treatment, a mixture of mechanical and chemical treatments or a chemical proper anodizing treatment; the surface of the thick-film aluminum electrode is made even and alumina, a nonconductive substance, on the surface is removed; the thick-film aluminum electrode obtains a surface with evenness and low oxygen content; and the thick-film aluminum electrode has similar quality as a thick-film electrode of noble metal silver for subsequent electroplating. Accordingly, a novel pretreatment of a thick-film aluminum electrode for metal plating is obtained.

### BRIEF DESCRIPTION OF THE DRAWINGS

The present invention will be better understood from the following detailed description of the preferred embodiment according to the present invention, taken in conjunction with the accompanying drawings, in which

FIG. 1 is the SEM view showing the surface of the thick-film aluminum electrode obtained after the mechanical grinding;

FIG. 2 is the analysis view showing the elements on the surface of the thick-film aluminum electrode obtained after the mechanical grinding;

FIG. 3 is the view showing the thick-film aluminum electrode obtained after the mechanical grinding with nickel and tin further plated;

FIG. 4 is the SEM view showing the surface of the thick-film aluminum electrode obtained after the alkaline washing and the acid washing;

FIG. 5 is the SEM view showing the thick-film aluminum electrode obtained after the chemical anodizing with nickel further plated;

FIG. 6 is the view showing the thick-film aluminum electrode obtained after the chemical anodizing with nickel and tin further plated;

FIG. 7 is the SEM view of the surface of the untreated thick-film aluminum electrode of the prior art; and

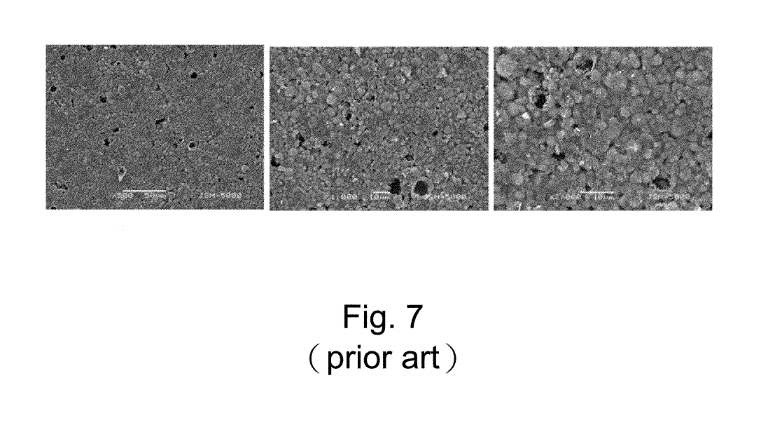

FIG. 8 is the view of the comparison between the thick-film aluminum electrode and the nickel/tin-plated silver electrode of the prior art.

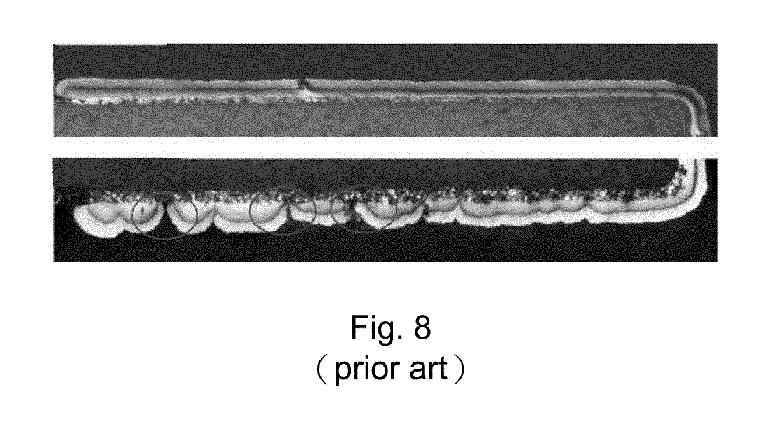

### DESCRIPTION OF THE PREFERRED EMBODIMENT

The following description of the preferred embodiment is provided to understand the features and the structures of the present invention.

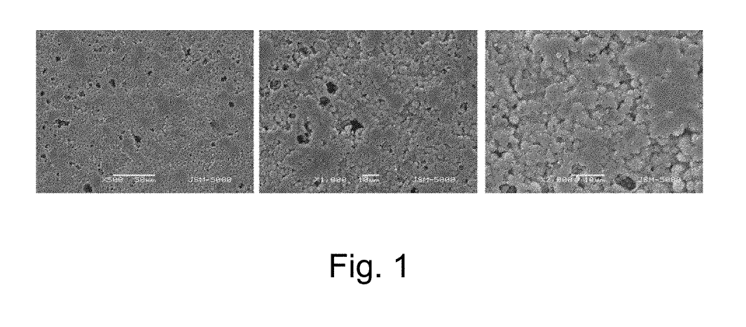

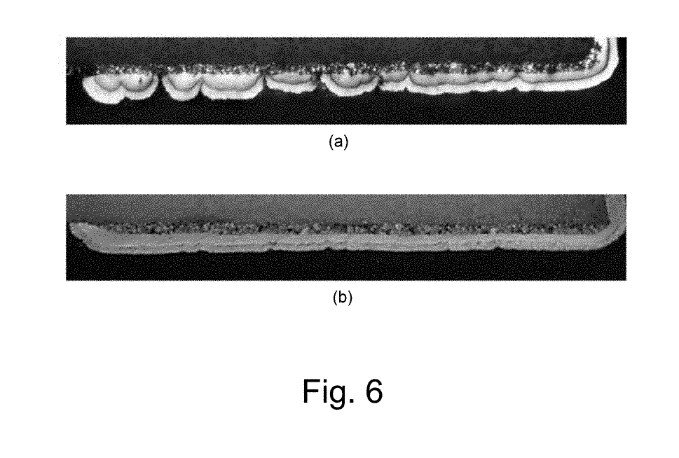

Please refer to FIG. 1˜FIG. 6, which are a SEM view showing the surface of a thick-film aluminum electrode obtained after a mechanical grinding; an analysis view showing elements on the surface of the thick-film aluminum electrode obtained after the mechanical grinding; a view showing the thick-film aluminum electrode obtained after the mechanical grinding with nickel and tin further plated; a SEM view showing the surface of a thick-film aluminum electrode obtained after an alkaline washing and an acid washing; a SEM view showing a thick-film aluminum electrode obtained after a chemical anodizing with nickel further plated; and a view showing a thick-film aluminum electrode obtained after a proper chemical anodizing with nickel and tin further plated. As shown in the figures, the present invention is a pretreatment of a thick-film aluminum electrode for metal plating, where a thick-film aluminum electrode is pretreated before performing subsequent metal plating; the thick-film aluminum electrode is pretreated with a purely mechanical or chemical treatment or a mixture of mechanical and chemical treatments; the chemical treatment is an alkaline/acid washing or a chemical anodizing; the surface of the thick-film aluminum electrode is made even and alumina, a nonconductive substance, on the surface is removed; the thick-film aluminum electrode obtains a surface with evenness and low oxygen content; and the thick-film aluminum electrode obtained has similar quality as the thick-film electrode of noble metal silver for subsequent metal plating. Thus, a novel pretreatment of a thick-film aluminum electrode for metal plating with thick-film aluminum electrode is obtained.

On using the present invention, the surface of a thick-film aluminum electrode is pretreated with a mechanical grinding, a chemical alkaline/acid washing or a chemical anodizing for a certain period of time. Therein, the evenness of the thick-film aluminum electrode is significantly improved and its oxygen content is greatly reduced for easily applying subsequent metal plating.

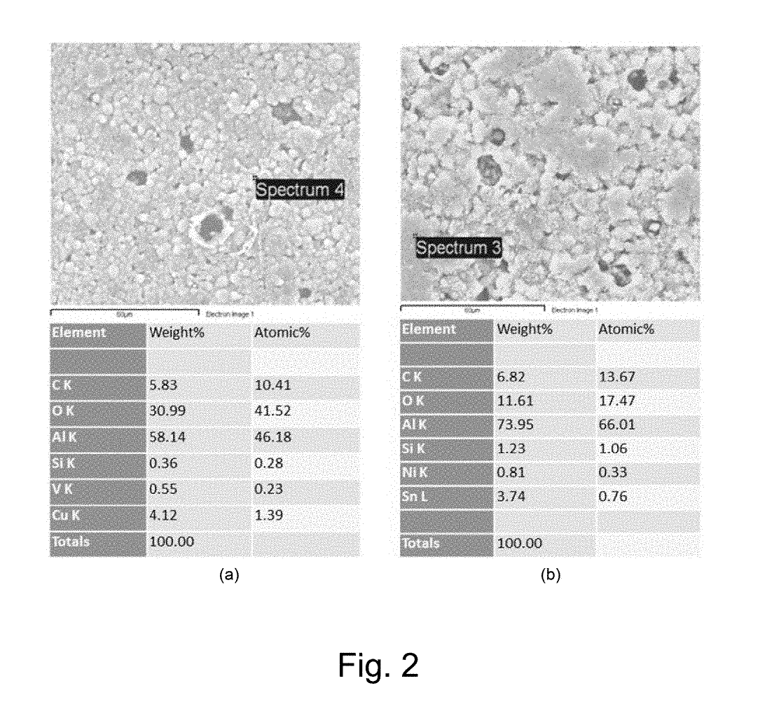

In a state-of-use of the mechanical grinding, the present invention mixes a chip resistor of thick-film aluminum electrode with a media of iron beads at a certain ratio in a cylindrical roller, where the media of iron beads has each bead a diameter of 0.5˜0.81 millimeters and the certain ratio for mixed the chip resistor of thick-film aluminum electrode with the media of iron beads is 1:10 for grounding 8 hours. Thus, the media of iron beads frictions with the chip resistor of thick-film aluminum electrode to make the surface of thick-film aluminum electrode even with alumina removed. Hence, the surface of the thick-film aluminum electrode obtains evenness greatly improved with the nonconductive substance alumina removed. In FIG. 1 , after the mechanical grinding like barreling or abrasive-paper polishing, the microstructure of the surface of the thick-film aluminum electrode is shown under different magnifications. Obviously, although some pores still appear, the surface is significantly improved in evenness. Furthermore, the present invention analyzes elements on the surfaces of the thick-film aluminum electrode treated through the mechanical grinding and an untreated thick-film aluminum electrode. In FIG. 2, picture (a) shows the electrode obtained without pretreatment and picture (b) shows the pretreated one. After comparison, a significant reduction in the oxygen content is observed, which means that the content of alumina left on the surface of the thick-film aluminum electrode is greatly reduced after the mechanical treatment.

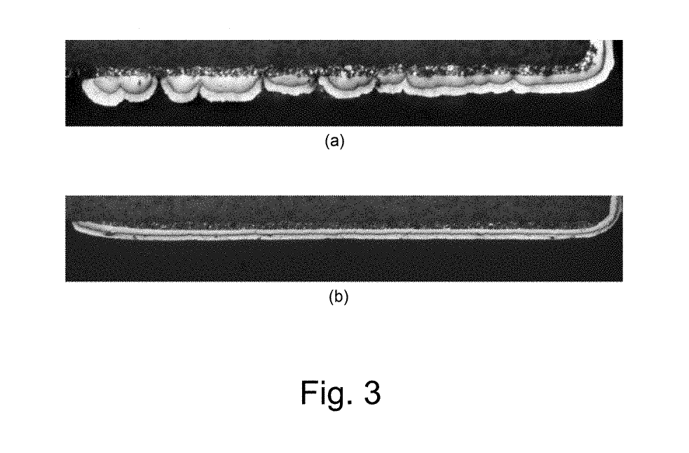

The present invention plates nickel and tin on the chip resistor of thick-film aluminum electrode after a mechanical grinding. Therein, after nickel is plated under a current of 21 amperes (A) for 40 minutes (min) and tin is plated under a current of 7 A for 40 min, the chip resistor of thick-film aluminum electrode is fabricated. In FIG. 3, picture (a) shows the electrode obtained without pretreatment, where the nickel-plated layer has a few places discrete. Picture (b) shows the thick-film aluminum electrode plated with nickel and tin after the mechanical grinding, where the pretreated electrode has similar quality as a thick-film silver electrode for plating nickel and tin with good continuity and evenness. It means that, in the present invention, the thick-film aluminum electrode plated with nickel and tin after the mechanical pretreatment can achieve a quality level just like the thick-film electrode of noble metal silver plated with nickel and tin.

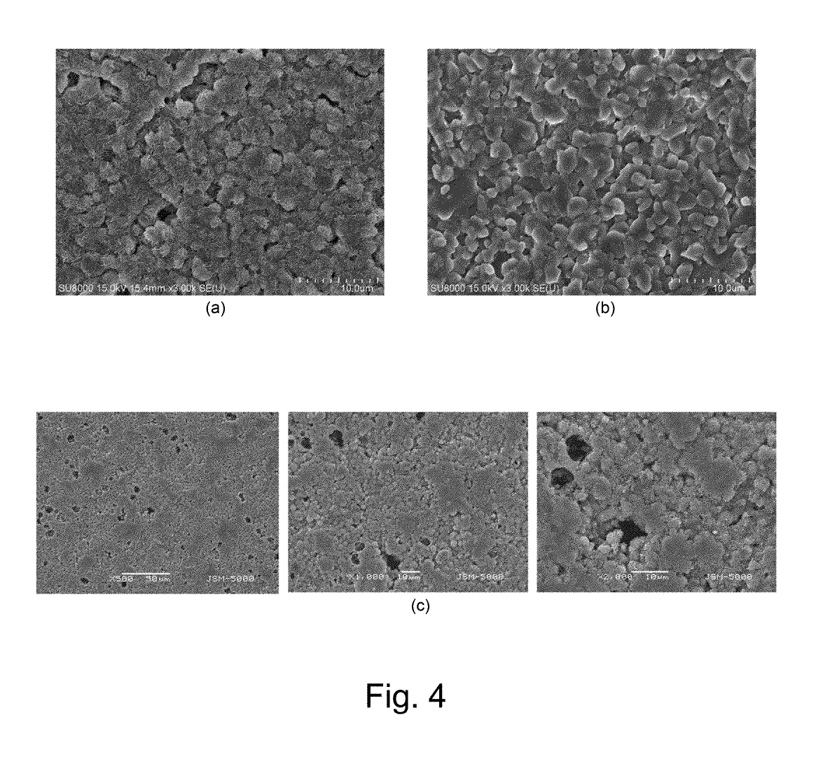

In a state-of-use of the chemical alkaline/acid washing, a chip resistor of thick-film aluminum electrode is put in a cylindrical roller and immersed in an alkaline solution (0.25M NaOH, temperature: 50° C.) or an acid solution (nickel sulfate: 410 g/l, sulfuric acid: 10%, temperature: 65° C.) for rolling about 15 min. After rolling, the alkaline or acid solution etches the chip resistor of thick-film aluminum electrode to make the surface of thick-film aluminum electrode even with alumina removed. Thus, the surface of thick-film aluminum electrode is significantly improved in evenness and the non-conductive substance alumina is removed. In FIG. 4, the microstructure of the surface of thick-film aluminum electrode obtained after the the pretreatment of chemical alkaline/acid washing is shown. Therein, picture (a) shows the microstructure of the surface before the chemical treatment; picture (b) after the alkaline treatment; and picture (c) after the acid treatment. Just like the mechanical pretreatment for the thick-film aluminum electrode, the evenness is significantly improved after the chemical alkaline/acid washing. Although pores on the surface of the thick-film aluminum electrode still exist, the thick-film aluminum electrode pretreated with the chemical alkaline/acid washing has similar quality as a thick-film silver electrode for plating nickel and tin with good continuity and evenness. It means that, in the present invention, the thick-film aluminum electrode plated with nickel and tin after the pretreatment of chemical alkaline/acid washing can achieve a quality level just like the thick-film electrode of noble metal silver plated with nickel and tin.

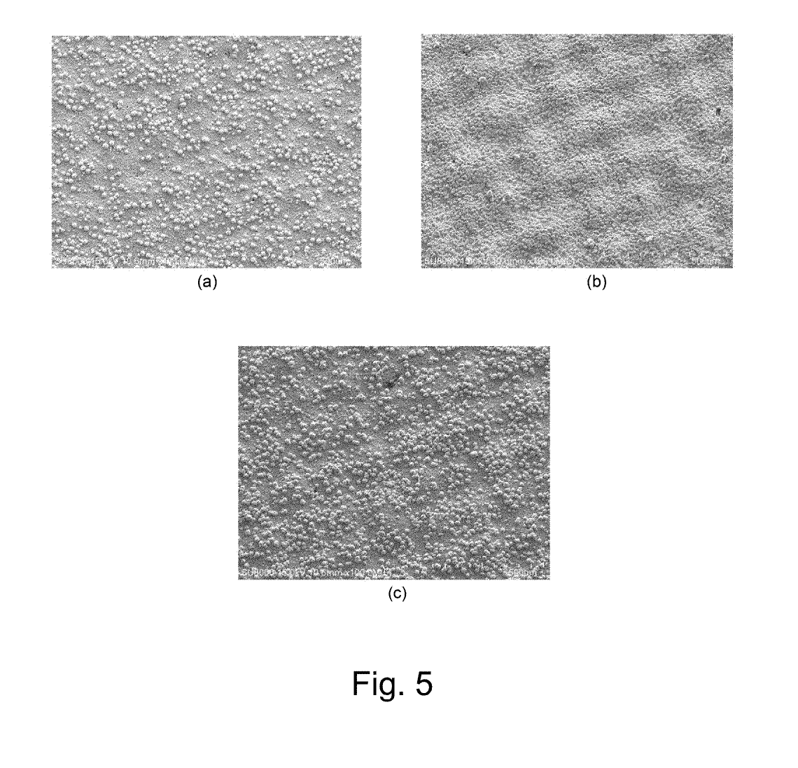

In a state-of-use of the chemical anodizing, a chip resistor of thick-film aluminum electrode is put in a cylindrical roller and immersed in an acid solution (phosphoric acid: 1/10 Vol %, temperature: 2˜65° C.). A platinum electrode is used as a cathode and the chip resistor of thick-film aluminum electrode is used as an anode to be applied with a voltage of 30 volts for processing the chemical anodizing. After being rolled for about 15 minutes, the chip resistor of thick-film aluminum electrode has the surface made even with alumina removed through an electrolytic reaction (Al→Al³⁺+3e−). Thus, the surface of thick-film aluminum electrode is significantly improved in evenness and the non-conductive substance alumina is removed. A plurality of the thick-film aluminum electrodes pretreated with the chemical anodizing for different periods of time are plated with nickel. In FIG. 5, the surfaces of the thick-film aluminum electrodes un-pretreated with, properly pretreated with and over-pretreated with chemical anodizing are shown in picture (a), picture (b) and picture (c), separately. The observation is as follows: The thick-film aluminum electrode un-pretreated with chemical anodizing is plated with nickel (Ni: 21 A, 60 min) and obtains discontinuous nickel granules plated. The thick-film aluminum electrode pretreated with chemical anodizing for 15 min is plated with nickel (Ni: 21 A, 60 min) and obtains a nickel layer with continuity. But, when the pretreatment of chemical anodizing is over-processed for 40 min with nickel plated afterwards, discontinuous nickel granules appear again during the plating owing to the reoccurring aluminum oxidation of the thick-film aluminum electrode. Hence, the present invention chooses the chip resistor of thick-film aluminum electrode pretreated with the proper chemical anodizing for plating nickel and tin. After being plated with nickel under a current of 21 A for 60 min and plated with tin under a current of 7 A for 60 min, the chip resistor of thick-film aluminum electrode is fabricated. After being pretreated with the proper chemical anodizing, the thick-film aluminum electrode is plated with nickel and tin. In FIG. 6, picture (a) shows a thick-film aluminum electrode without pretreatment, where the nickel layer plated has a few places discrete. Picture (b) shows the thick-film aluminum electrode pretreated with the proper chemical anodizing as followed by nickel-and tin-plating, which electrode achieves a quality level just like the thick-film electrode of noble metal silver for plating nickel and tin with good continuity and evenness. Consequently, the thick-film aluminum electrode pretreated with the proper chemical anodizing as followed by nickel-and tin-plating can achieve a quality level just like the thick-film electrode of noble metal silver plated with nickel and tin.

Accordingly, the present invention solves the problem of the subsequent metal plating for the thick-film aluminum electrode. Through the purely mechanical pretreatment, the pure chemical alkaline/acid washing pretreatment, the mixture of the mechanical and chemical pretreatments or the chemical proper anodizing pretreatment, the evenness and oxygen content of the thick-film aluminum electrode are significantly improved. Thus, the pretreated thick-film aluminum electrode has similar quality as a thick-film electrode of noble metal silver for subsequent metal plating.

To sum up, the present invention is a pretreatment of a thick-film aluminum electrode for metal plating, where a thick-film aluminum electrode is pretreated for subsequent metal plating; the pretreatment is a purely mechanical treatment, a purely chemical alkaline/acid washing treatment, a mixture of mechanical and chemical treatments or a chemical proper anodizing treatment; the surface of the thick-film aluminum electrode is made even and alumina, a nonconductive substance, on the surface is removed; the thick-film aluminum electrode obtains a surface with evenness and low oxygen content; and, hence, the novel thick-film aluminum electrode has similar quality as the thick-film electrode of noble metal silver for subsequent metal plating.

The preferred embodiment herein disclosed is not intended to unnecessarily limit the scope of the invention. Therefore, simple modifications or variations belonging to the equivalent of the scope of the claims and the instructions disclosed herein for a patent are all within the scope of the present invention.

What is claimed is:

1. A pretreatment of thick-film aluminum electrode for metal plating,
wherein a thick-film aluminum electrode is pretreated before performing subsequent metal plating; the thick-film aluminum electrode is pretreated with a purely mechanical or chemical treatment or a mixture of mechanical and chemical treatments; the chemical treatment is an alkaline/acid washing or a chemical anodizing; the surface of said thick-film aluminum electrode is made even and alumina, a nonconductive substance, on the surface is removed; said thick-film aluminum electrode obtains a surface with evenness and low oxygen content; and the thick-film aluminum electrode obtained has similar quality as the thick-film electrode of noble metal silver for subsequent metal plating.

2. The method according to claim 1,
wherein said purely mechanical treatment is a mechanical grinding;
wherein said thick-film aluminum electrode is mixed with a media of iron beads at a certain ratio to be ground in a cylindrical roller; and
wherein said media of iron beads frictions with said thick-film aluminum electrode to make said surface of said thick-film aluminum electrode even and remove alumina on said surface of said thick-film aluminum electrode.

3. The method according to claim 2,
wherein said media of iron beads has each bead a diameter of 0.55˜0.81 millimeters; and
wherein said thick-film aluminum electrode is mixed with said media of iron beads at a ratio of 1:10 to be ground for 6.5˜9.5 hours.

4. The method according to claim 1,
wherein said purely chemical treatment which is selected from a group consisting of said alkaline washing and said acid washing obtains said thick-film aluminum electrode in said cylindrical roller to be rolled and immersed in a corresponding solution which is selected from a group consisting of an alkaline solution and an acid solution; and
wherein said corresponding solution is reacted with said thick-film aluminum electrode to make said surface of said thick-film aluminum electrode even and remove alumina on said surface of said thick-film aluminum electrode.

5. The method according to claim 4,
wherein said alkaline washing is processed at a temperature of 40˜60 celsius degrees (° C.) for 12˜18 minutes (min).

6. The method according to claim 4,
wherein said alkaline solution is selected from a group consisting of sodium hydroxide (NaOH), ammonium hydroxide and a combination of NaOH and ammonium hydroxide.

7. The method according to claim 4,
wherein said acid washing is processed at a temperature of 50˜80° C. for 12˜18 min.

8. The method according to claim 4,
wherein said alkaline solution is selected from a group consisting of nickel sulfate, sulfuric acid and a combination of nickel sulfate and sulfuric acid.

9. The method according to claim 1,
wherein, within said chemical anodizing, said thick-film aluminum electrode in said cylindrical roller is rolled and immersed in said acid solution; with a platinum electrode as a cathode and said thick-film aluminum electrode as a anode, an anodic reaction is processed with a voltage of 25˜35 volts; and, through said anodic reaction, said surface of said thick-film aluminum electrode is made even and alumina on said surface of said thick-film aluminum electrode is removed.

10. The method according to claim 9,
wherein said acid washing is processed at a temperature of 25˜65° C. for 12˜18 min.

11. The method according to claim 9,
wherein said acid solution is of phosphoric acid.
